(19) United States
(12) Patent Application Publication
(10) Pub. No.: US 2025/0044716 A1
(43) Pub. Date: Feb. 6, 2025

(54) ELECTROPHOTOGRAPHIC MEMBER, PROCESS CARTRIDGE, AND ELECTROPHOTOGRAPHIC IMAGE FORMING APPARATUS

(71) Applicant: CANON KABUSHIKI KAISHA, Tokyo (JP)

(72) Inventors: NAOTO KAMEYAMA, Tokyo (JP); KAORU OKAMOTO, Chiba (JP)

(21) Appl. No.: 18/778,594

(22) Filed: Jul. 19, 2024

(30) Foreign Application Priority Data
Jul. 26, 2023 (JP) 2023-121972

(51) Int. Cl. G03G 5/147; G03G 15/01; G03G 15/16

(52) U.S. Cl. CPC G03G 5/14752; G03G 5/14704; G03G 5/14734; G03G 15/0131; G03G 15/0189; G03G 15/162; G03G 2215/00957; G03G 2215/00962; G03G 2221/183

(57) ABSTRACT

An electrophotographic member at least comprising: a base layer; and a surface layer on the base layer, wherein the surface layer comprises a binder resin, a tin oxide-containing particle, and at least one copolymer selected from the group consisting of a polyoxyethylene-polycaprolactone copolymer and a polyoxyethylene-polyvalerolactone copolymer; the binder resin comprises a (meth)acrylic resin; the copolymer has at least one functional group selected from the group consisting of a carboxy group and a phosphate group; and a content percentage of the particle in relation to the surface layer is 2.0% to 10.0% by volume.

### BACKGROUND OF THE INVENTION

### Field of the Invention

The present disclosure relates to an electrophotographic member used for electrophotographic image forming apparatuses, such as copiers or printers, a process cartridge, and an electrophotographic image forming apparatus.

### Description of the Related Art

In an image forming apparatus of the electrophotographic system, a tandem system, which includes forming a toner image on a photoreceptor, superimposing toner images of Y (yellow), M (magenta), C (cyan), and K (black) colors on an intermediate transfer belt, and then transferring the toner images all together onto a paper sheet to obtain full-color images, have widely been used.

In an electrophotographic device, which requires high-speed printing and maintenance-free operation, photoreceptors and intermediate transfer belts are required to have even higher durability. In order to achieve higher durability, it has been necessary to make the photoconductors and intermediate transfer belts less susceptible to wear. Thus, attempts are being made to coat the surface layer of an electrophotographic member with a resin containing dispersed inorganic fillers to make the photoconductors and intermediate transfer belts less susceptible to wear and to ensure higher durability. Since the resin in the surface layer has insulating properties in this configuration, electric discharging occurs in a charging section, a primary transfer section, and a secondary transfer section, often causing image faults. Therefore, a conductive filler containing tin oxide as an inorganic filler is used.

In Japanese Patent Application Publication No. 2016-126163, a configuration in which a conductive filler, antimony-doped tin oxide or phosphorous-doped tin oxide, is added to an acrylic resin as a surface layer of an organic photoreceptor is used. In Japanese Patent Application Publication No. 2017-187558, a configuration in which metal oxide fine particles are added to an acrylic resin as a surface layer of an intermediate transfer belt is used.

### SUMMARY OF THE INVENTION

At least one aspect of the present disclosure directs to the provision of an electrophotographic member that contributes to the stable formation of high-quality electrophotographic images. At least one aspect of the present disclosure directs to the provision of a process cartridge capable of stably forming high-quality electrophotographic images.

Furthermore, at least one aspect of the present disclosure directs to the provision of an electrophotographic image forming apparatus capable of stably forming high-quality electrophotographic images.

One embodiment of the present disclosure provides an electrophotographic member at least comprising:
a base layer; and
a surface layer on the base layer, wherein
the surface layer comprises a binder resin, a tin oxide-containing particle, and at least one copolymer selected from the group consisting of a polyoxyethylene-polycaprolactone copolymer and a polyoxyethylene-polyvalerolactone copolymer;
the binder resin comprises a (meth)acrylic resin;
the copolymer has at least one functional group selected from the group consisting of a carboxy group and a phosphate group; and
a content percentage of the particle in relation to the surface layer is 2.0% to 10.0% by volume.

According to at least one aspect of the present disclosure, an electrophotographic member capable of forming good electrophotographic images over a long period of time is provided. According to one aspect of the present disclosure, a process cartridge capable of stably forming high-quality electrophotographic images is provided. Furthermore, according to one aspect of the present disclosure, an electrophotographic image forming apparatus capable of stably forming high-quality electrophotographic images. Further features of the present invention will become apparent from the following description of exemplary embodiments with reference to the attached drawings.

### BRIEF DESCRIPTION OF THE DRAWINGS

FIG. 1 is a diagram of an electrophotographic image forming apparatus;

FIG. 2 is a cross-sectional configuration example of an intermediate transfer belt;

FIG. 3 is a cross-sectional configuration example of a photosensitive drum;

FIG. 4 is a cross-sectional configuration example of a process cartridge; and

FIG. 5A is a surface SEM observation image of the surface layer, and FIG. 5B is a binarized image thereof.

### DESCRIPTION OF THE EMBODIMENTS

In the present disclosure, statements of “from XX to YY” and “XX to YY” each representing a numerical value range mean numerical value ranges including lower limits and upper limits, which are endpoints, unless otherwise particularly specified. When numerical value ranges are stepwise stated, the upper and lower limits of the individual numerical value ranges can optionally be combined. In addition, in the present disclosure, such a statement as, e.g., “at least one selected from the group consisting of XX, YY, and ZZ” means any of XX, YY, ZZ, a combination of XX and YY, a combination of XX and ZZ, a combination of YY and ZZ, and a combination of XX, YY, and ZZ.

Unless otherwise stated, the environment for the measurement value is 23° C. and 50% RH.

In the present disclosure, “Q/sq.” is a unit of surface resistivity defined in Japanese Industrial Standards (JIS) K 6911:2006 and means “Q per square”.

In the studies of the present inventors, if a large amount of conductive filler was added to increase the conductivity of the surface layer in the photoreceptor of Japanese Patent Application Publication No. 2016-126163, the light transmittance of the surface layer may be reduced, which sometimes made it difficult to form high-quality latent images. On the contrary, when the conductive filler content was reduced in order to make the light transmittance of the surface layer higher, the conductivity of the surface layer was reduced.

If the conductive filler content was increased to make the conductivity of the surface layer higher in the intermediate transfer member of Japanese Patent Application Publication No. 2017-187558, the hardness of the surface layer increases, and scratches may be caused on the surface of other members in contact with the intermediate transfer member, for example, an electrophotographic photoreceptor, or may lead to wear of the cleaning materials for cleaning the surface of an intermediate transfer belt.

In view of the above problem, the present inventors recognized the need to develop conductive resin films with high conductivity while keeping the content of conductive particles low. Under such a recognition, the present inventors have further proceeded with the studies and, as a result, found that a cured product of the coated film of a coating composition containing a tin oxide-containing particle (hereinafter referred to as a “tin oxide particle”) as a conductive particle, at least one copolymer selected from the group consisting of a polyoxyethylene-polycaprolactone copolymer and a polyoxyethylene-polyvalerolactone copolymer, and raw materials of a (meth)acrylic resin can exhibit high conductivity while keeping the content of conductive particles small.

The reason why the cured product described above exhibits high conductivity even though the content of a conductive tin oxide particle is small is inferred that at least one copolymer selected from the group consisting of a polyoxyethylene-polycaprolactone copolymer and a polyoxyethylene-polyvalerolactone copolymer can moderately agglomerate the tin oxide particle in the coated film, resulting in the efficient formation of a conductive path by the tin oxide particle in the cured product.

Preferable embodiments of the present invention will be described below in detail with reference to the drawings. However, the dimensions, materials, shapes, relative arrangements, and the like of the constituent components described in the following embodiments should be changed, as appropriate, based on the constitution of apparatuses and various conditions to which the present invention is applied and are not intended to limit the scope of the present invention thereto alone.

At least one embodiment of the present disclosure relates to an electrophotographic member at least comprising:
a base layer; and
a surface layer on the base layer, wherein
the surface layer comprises a binder resin, a tin oxide-containing particle, and at least one copolymer selected from the group consisting of a polyoxyethylene-polycaprolactone copolymer and a polyoxyethylene-polyvalerolactone copolymer;
the binder resin comprises a (meth)acrylic resin;
the copolymer has at least one functional group selected from the group consisting of a carboxy group and a phosphate group; and
a content percentage of the particle in relation to the surface layer is 2.0% to 10.0% by volume.

### Electrophotographic Member

The electrophotographic member of the present disclosure at least has a base layer and a surface layer on the base layer.

The material of the base layer is not particularly limited, and well-known materials may be used depending on the use of the electrophotographic member. Details will be described later.

The surface layer contains a binder resin. The binder resin contains a (meth)acrylic resin. The term “(meth)acrylic resins” is a generic term for methacrylic resins and acrylic resins. (Meth)acrylic resins refer to copolymers of acrylic acid esters or methacrylic acid esters. Here, acrylic acid esters and methacrylic acid esters are not particularly limited and may include, for example, those having a functional group other than ester bonds, such as urethane acrylate or urethane methacrylate. The inclusion of a (meth)acrylic resin improves adhesiveness and mechanical strength between the surface layer and the base layer.

The content percentage of the binder resin in the surface layer is not particularly limited and preferably 20% to 90% by mass in relation to the mass of the total solid content of the surface layer in order to retain excellent strength of the surface layer and to have excellent toner release properties on the outer surface of the surface layer.

The surface layer can be formed as a cured film by, for example, polymerizing a composition that contains a monomer with a polymerizable functional group (polymerizable monomer). The polymerization reaction is not particularly limited, and examples thereof may include thermal polymerization reactions, photopolymerization reactions, radiation polymerization reactions, and the like. The polymerizable functional group of the monomer having a polymerizable functional group is not particularly limited as long as a (meth)acrylic resin can be formed, and examples thereof may include a methacrylic group, an acrylic group, an epoxy group, and the like.

Examples of polymerizable monomers for forming a (meth)acrylic resin may include the following acrylates of (i), methacrylates of (ii), urethane acrylates of (iii), and urethane methacrylates of (iv). Polymerizable monomers that are marketed for paints can also be used.
(i) At least one acrylate selected from the group consisting of pentaerythritol triacrylate, pentaerythritol tetraacrylate, ditrimethylolpropane tetraacrylate, dipentaerythritol hexaacrylate, an alkyl acrylate, benzyl acrylate, phenyl acrylate, ethylene glycol diacrylate, and bisphenol A diacrylate;
(ii) at least one methacrylate selected from the group consisting of pentaerythritol trimethacrylate, pentaerythritol tetramethacrylate, ditrimethylolpropane tetramethacrylate, dipentaerythritol hexamethacrylate, an alkyl methacrylate, benzyl methacrylate, phenyl methacrylate, ethylene glycol dimethacrylate, and bisphenol A dimethacrylate;
(iii) at least one acrylate selected from the group consisting of polyether-based urethane acrylate and polyester-based urethane acrylate; and
(iv) at least one acrylate selected from the group consisting of polyether-based urethane methacrylate and polyester-based urethane methacrylate.

The surface layer preferably has high hardness, considering that the surface layer will be rubbed against other members. Thus, it is also preferable to use a crosslinking monomer with two or more functional groups for a (meth)acrylic resin. This allows the surface layer to have high hardness.

In other words, among the acrylates of (i), at least one selected from the group consisting of pentaerythritol triacrylate, pentaerythritol tetraacrylate, ditrimethylolpropane tetraacrylate, and dipentaerythritol hexaacrylate is more preferable. At least one selected from the group consisting of pentaerythritol triacrylate and pentaerythritol tetraacrylate is further preferable.

Among the methacrylates of (ii), at least one selected from the group consisting of pentaerythritol trimethacrylate, pentaerythritol tetramethacrylate, ditrimethylolpropane tetramethacrylate, and dipentaerythritol hexamethacrylate is more preferable. At least one selected from the group consisting of pentaerythritol trimethacrylate and pentaerythritol tetramethacrylate is further preferable.

Furthermore, among the acrylates of (iii), at least one selected from the group consisting of polyether-based urethane acrylates with two or more functional groups is more preferable, at least one selected from the group consisting of polyether-based urethane acrylates with four or more functional groups is further preferable, and at least one selected from the group consisting of polyether-based urethane acrylates with six or more functional groups is still further preferable. Such a urethane acrylate may include U-6LPA (trade name, manufactured by Shin-Nakamura Chemical Co., Ltd.).

In addition, among the acrylates of (iv), at least one selected from the group consisting of polyether-based urethane methacrylates with two or more functional groups is more preferable, at least one selected from the group consisting of polyether-based urethane methacrylates with four or more functional groups is further preferable, and at least one selected from the group consisting of polyether-based urethane methacrylates with six or more functional groups is still further preferable.

To form a (meth)acrylic resin from such a polymerizable monomer, there is a method of adding a photopolymerization initiator and polymerizing the monomer using electron beams or UV rays.

Examples of photopolymerization initiators may include radical-generating photopolymerization initiators such as benzophenone, thioxanthone-based photopolymerization initiators, benzyl dimethyl ketal, α-hydroxyketone, α-hydroxyalkylphenone, α-aminoketone, α-aminoalkylphenone, monoacyl phosphine oxide, bis(acyl)phosphine oxide, hydroxybenzophenone, aminobenzophenone, titanocene-based photopolymerization initiators, oxime esters, and oxyphenylacetic acid esters.

### Tin Oxide-Containing Particle

The surface layer contains a tin oxide-containing particle. The tin oxide particle is not particularly limited, and, for example, an antimony-doped tin oxide particle, a phosphorous-doped tin oxide particle, a tin oxide particle with oxygen defects, or the like may be used. These are preferable since electric resistance is low and easily available. Among them, at least one selected from the group consisting of an antimony-doped tin oxide particle and a phosphorous-doped tin oxide particle is more preferable, and an antimony-doped tin oxide particle or a phosphorous-doped tin oxide particle is further preferable.

The content percentage of the tin oxide particle in relation to the surface layer is 2.0% to 10.0% by volume. The content percentage is preferably 2.5% to 8.0% by volume and more preferably 3.0% to 6.0% by volume. When the above content percentage is within the above range, the surface resistivity and volume resistivity of the surface layer are suitable, and high-quality electrophotographic images can be formed. When the content percentage is 2.0% by volume or more, high conductivity can be imparted to the surface layer. In contrast, when the content percentage is 10.0% by volume or less, the surface layer can be prevented from being too hard.

### Polyoxyethylene-Polycaprolactone Copolymer and Polyoxyethylene-Polyvalerolactone Copolymer

When a surface layer is formed by a cured product of a coated film of a surface layer-forming paint containing at least one copolymer selected from the group consisting of a polyoxyethylene-polycaprolactone copolymer and a polyoxyethylene-polyvalerolactone copolymer (hereinafter also simply referred to as a “copolymer”) in addition to a conductive tin oxide particle and raw materials of a (meth)acrylic resin (monomer, oligomer, or the like), the tin oxide-containing particle in the surface layer can be made in a desired agglomerated state. As a result, high conductivity can be imparted to the surface layer.

For example, in order to prepare a copolymer, a method including ring-opening polymerization of F-caprolactone under the presence of polyoxyethylene having an OH group terminal, such as alcohol ethoxylate, may be mentioned.

The copolymer has at least one functional group selected from the group consisting of a carboxy group and a phosphate group. If the copolymer contains such a functional group, the copolymer is more easily adsorbed on the surface of the tin oxide particle, resulting in improved affinity between the tin oxide-containing particle and the copolymer. For example, in order to make the copolymer have such a functional group, if the copolymer precursor contains a hydroxy group, a method of converting the hydroxy group into a carboxy group or phosphate group by an oxidation reaction may be mentioned.

The content percentage of the copolymer in the surface layer is not particularly limited and preferably 0.02% to 1.00% by mass.

The number average molecular weight of the copolymer is not particularly limited, and preferably 500 to 2,500, more preferably 600 to 2,000, and further preferably 800 to 1,500. When the number average molecular weight is within the above range, it is easier to achieve the desired dispersion state of tin oxide-containing particles.

The content percentage of the polyoxyethylene unit in the copolymer is not particularly limited and preferably 20% to 55% by mass, more preferably 22% to 49% by mass, and further preferably 29% to 44% by mass. When the content percentage is within the above range, the compatibility with a binder resin is better, and the copolymer is more easily adsorbed on the tin oxide-containing particle.

The surface layer may contain additives such as an antioxidant, a UV ray absorber, a plasticizer, a leveling agent, a slipperiness-imparting agent, and a wear resistance-improving agent. Specific examples of additives may include a hindered phenol compound, a hindered amine compound, a sulfur compound, a phosphorous compound, a benzophenone compound, a siloxane-modified resin, silicone oil, a fluororesin particle, a polystyrene resin particle, a polyethylene resin particle, a silica particle, an alumina particle, a boron nitride particle, and the like. For example, the surface layer may also contain an organic compound with charge transport properties or a conductive filler other than the tin oxide-containing particle.

Conductive filler is not particularly limited as long as the filler has conductivity, and examples thereof may include a metal oxide such as zinc oxide or indium oxide, carbon black, metal, and the like.

The arithmetic average film thickness of the surface layer is not particularly limited and, for example, preferably 0.5 to 10 μm and more preferably 2 to 10 μm. When the arithmetic average film thickness is within the above range, it is easier to maintain the surface layer even after several hundreds of thousands of prints, and also, the frequency of the occurrence of cracking and warpage due to sliding is reduced.

If the surface layer is formed using a paint, the arithmetic average film thickness of the surface layer can be adjusted by the solid concentration of the paint and the amount of the paint placed on the surface during coating.

### Electrophotographic Photoreceptor

The electrophotographic member of the present disclosure may be used as an electrophotographic photoreceptor. In other words, the electrophotographic member may be an electrophotographic photoreceptor. In this embodiment, an electrophotographic photoreceptor having constituents of a conductive support/a conductive layer/an undercoating layer/a photosensitive layer/a protective layer in this order will be described. In this case, the protective layer corresponds to the surface layer of the electrophotographic member, and layers other than the protective layer, such as a conductive layer, an undercoating layer, a photosensitive layer, and the like correspond to the base layer of the electrophotographic member. However, the present disclosure is not limited to this. For example, the electrophotographic photoreceptor may not contain a protective layer.

The electrophotographic photoreceptor of the present disclosure preferably includes a photosensitive layer. As a photosensitive layer, the electrophotographic photoreceptor may include a monolayer-type photosensitive layer or may include a laminated-type photosensitive layer, as described later. When the electrophotographic photoreceptor includes a monolayer-type photosensitive layer, the electrophotographic photoreceptor preferably has a monolayer-type photosensitive layer and a protective layer to protect the monolayer-type photosensitive layer. When the electrophotographic photoreceptor includes a laminated-type photosensitive layer, the electrophotographic photoreceptor preferably has a laminated-type photosensitive layer and a protective layer to protect the laminated-type photosensitive layer. In these cases, the protective layer corresponds to the surface layer of the electrophotographic member.

The electrophotographic photoreceptor of the present disclosure may have a conductive support, and a charge generation layer and a charge transport layer on the outside of the conductive support in this order. Furthermore, at least one selected from the group consisting of a conductive layer and an undercoating layer may be disposed between the conductive support and the charge generation layer. A protective layer may be formed on the charge transport layer.

As the method for producing the electrophotographic photoreceptor of the present disclosure, a method including preparing a coating solution for each layer described later, coating the coating solution in the order of the desired layers, and curing the coating solution by drying under heating, electron beam irradiation, or the like may be mentioned. As the coating method of the coating solution in this method, dip coating, spray coating, ink jet coating, roll coating, die coating, blade coating, curtain coating, wire bar coating, ring coating, and the like may be mentioned. Among them, dip coating is preferable from the viewpoint of efficiency and producibility.

The constituents of the electrophotographic photoreceptor, such as a conductive support, a conductive layer, an undercoating layer, a photosensitive layer, and a protective layer, will be each described below. In the explanation of the photosensitive layer, (1) a laminated-type photosensitive layer and (2) a monolayer-type photosensitive layer will also be described.

### Conductive Support

The electrophotographic photoreceptor may contain a conductive support. The shape of the conductive support is not particularly limited and may be, for example, cylindrical, belt-shaped, or sheet-shaped. Among them, a cylindrical shape is preferable. The size of the conductive support is not particularly limited, and, for example, when the conductive support is cylindrical, the diameter may be 20 to 40 mm, and the length of the axis direction may be 200 to 500 mm. The thickness of the conductive support is 0.1 to 2.0 mm.

An electrochemical treatment, such as anode oxidation, blast processing, cutting processing, or other processing may be applied to the surface of the conductive support.

The material of the conductive support is not particularly limited, and metals, resins, glass, and the like are preferable. Examples of metals may include aluminum, iron, nickel, copper, gold, stainless steel, alloys thereof, and the like. Among them, a support made of aluminum using aluminum is preferable.

When a resin or glass is used, a support with conductivity imparted by mixing or coating of a conductive material is preferable.

### Conductive Layer

The electrophotographic photoreceptor may have a conductive layer on the conductive support. The presence of the conductive layer allows for concealing scratches or unevenness on the surface of the conductive support and controlling the light reflection on the surface of the conductive support.

The conductive layer preferably contains a conductive filler and a resin.

The material for the conductive filler is not particularly limited, and examples thereof may include metal oxides, metals, carbon black, and the like.

Examples of metal oxides may include zinc oxide, aluminum oxide, indium oxide, silicon oxide, zirconium oxide, tin oxide, titanium oxide, magnesium oxide, antimony oxide, bismuth oxide, and the like. Examples of metals may include aluminum, nickel, iron, nichromium, copper, zinc, silver, and the like.

Among them, as a conductive filler, a metal oxide is preferably used, and particularly, titanium oxide, tin oxide, and zinc oxide are more preferably used.

When a metal oxide is used as a conductive filler, the surface of a metal oxide may be treated with a silane coupling agent and the like, or elements, such as phosphorous or aluminum, or an oxide thereof may be doped to the metal oxide.

The conductive filler preferably includes a conductive particle. The conductive particle may have a laminated structure with a core particle and a coat layer to cover the particle. Examples of core particles may include titanium oxide, barium sulfate, zinc oxide, and the like. Examples of coat layers may include metal oxides, such as tin oxide.

When a metal oxide is used as the conductive filler, the volume average particle diameter of the metal oxide is preferably 1 to 500 nm and more preferably 3 to 400 nm.

Resins used for the conductive layer are not particularly limited, and examples thereof may include a polyester resin, a polycarbonate resin, a polyvinyl acetal resin such as a polyvinyl butyral resin, a (meth)acrylic resin, a silicone resin, an epoxy resin, a melamine resin, a polyurethane resin, a phenol resin, an alkyd resin, and the like. Among them, a polyvinyl acetal resin is preferable.

The conductive layer may further contain concealing agents, such as silicone oil, resin particles, or titanium oxide.

The arithmetic average film thickness of the conductive layer is preferably 1 to 50 μm and particularly preferably 3 to 40 μm.

The conductive layer may be formed by preparing a coating solution for conductive layers containing the materials described above and a solvent, forming a coated film of this coating solution, and curing the coating solution by heating and drying or the like. Examples of solvents used in the coating solution for conductive layers may include alcohol-type solvents, sulfoxide-type solvents, ketone-type solvents, ether-type solvents, ester-type solvents, aromatic hydrocarbon-type solvents, and the like. Examples of dispersing methods for dispersing a conductive filler in the coating solution for conductive layers may include methods using a paint shaker, a sand mill, a ball mill, or a liquid collision-type high-speed disperser.

### Undercoating Layer

The electrophotographic photoreceptor may contain an undercoating layer on a conductive support or a conductive layer. The presence of an undercoating layer enhances the adhesive function between layers and imparts a charge injection-blocking function.

It is preferable that the undercoating layer further contains a resin. The undercoating layer may be formed as a cured layer by polymerizing a composition that contains a monomer having a polymerizable functional group.

The resin used for the undercoating layer is not particularly limited, and examples thereof may include a polyester resin, a polycarbonate resin, a polyvinyl acetal resin such as a polyvinyl butyral resin, a (meth)acrylic resin, an epoxy resin, a melamine resin, a polyurethane resin, a phenol resin, a polyvinyl phenol resin, an alkyd resin, a polyvinyl alcohol resin, a polyethylene oxide resin, a polypropylene oxide resin, a polyamide resin, a polyamic acid resin, a polyimide resin, a polyamide imide resin, a cellulose resin, and the like.

Examples of polymerizable functional groups of a monomer having a polymerizable functional group may include an isocyanato group, a block isocyanato group, a methylol group, an alkylated methylol group, an epoxy group, a metal alkoxide group, a hydroxy group, an amino group, a carboxy group, a thiol group, a carboxylic anhydride group, a carbon-carbon double bond group such as a vinyl group, and the like.

Furthermore, the undercoating layer may further contain an electron transport substance, a metal oxide, a metal, a conductive polymer, and the like in order to increase the electrical properties. Among them, it is preferable to use at least one selected from the group consisting of an electron transport substance and a metal oxide.

Examples of electronic transport substances may include a quinone compound, an imide compound, a benzimidazole compound, a cyclopentadienylidene compound, a fluorenone compound, a xanthone compound, a benzophenone compound, a cyanovinyl compound, a halogenated aryl compound, a silole compound, a boron-containing compound, and the like. The undercoating layer may be formed as a cured layer by copolymerizing an electron transport substance having a polymerizable functional group as an electron transport substance with a monomer having a polymerizable functional group described above.

Examples of metal oxides may include indium tin oxide, tin oxide, indium oxide, titanium oxide, zinc oxide, aluminum oxide, silicon dioxide, and the like. Examples of metals may include gold, silver, aluminum, and the like.

The undercoating layer may further contain an additive such as silicone oil.

The arithmetic average film thickness of the undercoating layer is preferably 0.1 to 50 μm, more preferably 0.2 to 40 μm, and particularly preferably 0.3 to 30 μm.

The undercoating layer may be formed by preparing a coating solution for undercoating layers containing the materials described above and a solvent, forming a coated film of this coating solution, and curing the coating solution by heating and drying or the like. Examples of solvents used in the coating solution may include alcohol-type solvents, ketone-type solvents, ether-type solvents, ester-type solvents, aromatic hydrocarbon-type solvents, and the like.

### Photosensitive Layer

The electrophotographic photoreceptor may have a photosensitive layer. Photosensitive layers are mainly classified as (1) laminated-type photosensitive layers and (2) monolayer-type photosensitive layers. Each will be described below.

### (1) Laminated-Type Photosensitive Layer

A laminated-type photosensitive layer has a charge generation layer and a charge transport layer. It is preferable that the charge transport layer is located on the charge generation layer. When the charge transport layer is located on the charge generation layer, and the electrophotographic photoreceptor does not have a protective layer, the charge transport layer corresponds to the surface layer of the electrophotographic member, and layers other than the charge transport layer correspond to the base layer of the electrophotographic member.

### (1-1) Charge Generation Layer

The charge generation layer contains a charge generation substance. It is preferable that the charge generation layer further contains a resin. A charge generation substance is a substance in which electrons in the HOMO orbit excite into the LUMO orbital by external stimuli, such as light, thereby generating electric charges and holes.

Examples of charge generation substances may include pigments such as azo pigments, perylene pigments, polycyclic quinone pigments, indigo pigments, and phthalocyanine pigments. Among them, azo pigments and phthalocyanine pigments are preferable. Among phthalocyanine pigments, a titanyl phthalocyanine pigment, a gallium phthalocyanine chloride pigment, and a gallium phthalocyanine hydroxide pigment are more preferable, and a gallium phthalocyanine hydroxide pigment is further preferable.

The content percentage of the charge generation substance in the charge generation layer is preferably 40% to 85% by mass and more preferably 60% to 80% by mass in relation to the total mass of the charge generation layer.

Examples of resins used for the charge generation layer may include a polyester resin, a polycarbonate resin, a polyvinyl acetal resin such as a polyvinyl butyral resin, a (meth)acrylic resin, a silicone resin, an epoxy resin, a melamine resin, a polyurethane resin, a phenol resin, a polyvinyl alcohol resin, a cellulose resin, a polystyrene resin, a polyvinyl acetate resin, a polyvinyl chloride resin, and the like. Among them, a polyvinyl butyral resin is more preferable.

The charge generation layer may further contain additives such as an antioxidant or a UV ray absorber. Specific examples thereof may include a hindered phenol compound, a hindered amine compound, a sulfur compound, a phosphorous compound, a benzophenone compound, and the like.

The arithmetic average film thickness of the charge generation layer is preferably 0.10 to 1.00 μm and particularly preferably 0.15 to 0.40 μm.

The charge generation layer may be formed by preparing a coating solution for charge generation layers containing the materials described above and a solvent, forming a coated film of this coating solution, and curing the coating solution by heating and drying or the like. Examples of solvents used in the coating solution may include alcohol-type solvents, sulfoxide-type solvents, ketone-type solvents, ether-type solvents, ester-type solvents, aromatic hydrocarbon-type solvents, and the like.

### (1-2) Charge Transport Layer

The charge transport layer contains a charge transport substance. It is preferable that the charge transport layer further contains a resin. A charge transport substance may also be referred to as a charge transfer substance and is a substance with high mobility of electrons or holes and capable of receiving electrons or holes generated in the charge generation layer.

Examples of charge transport substances may include a polycyclic aromatic compound, a heterocyclic compound, a hydrazone compound, a styryl compound, an enamine compound, a benzidine compound, and a triaryl amine compound, a resin having a group derived from these substances, and the like. Among them, a triaryl amine compound and a benzidine compound are preferable. The benzidine compound is not particularly limited, and, for example, the compound represented by the formula (B) below may be mentioned. The triaryl amine compound is not particularly limited, and, for example, at least one selected from the group consisting of the compound represented by the formula (C) below and a compound represented by the formula (D) below may be mentioned.

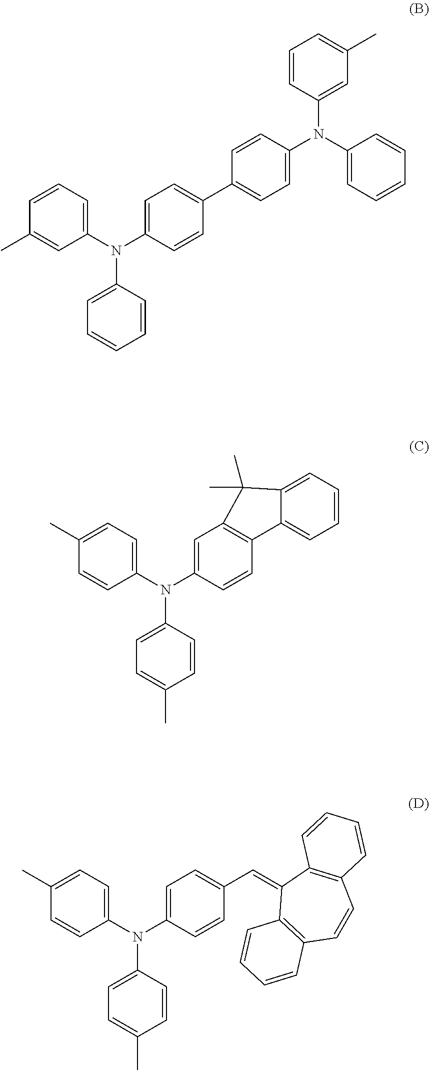 [SMILES: Cc1cccc(N(c2ccccc2)c2ccc(-c3ccc(N(c4ccccc4)c4cccc(C)c4)cc3)cc2)c1 ; Cc1ccc(N(c2ccc(C)cc2)c2ccc3c(c2)C(C)(C)c2ccccc2-3)cc1 ; Cc1ccc(N(c2ccc(C)cc2)c2ccc(C=C3c4ccccc4C=Cc4ccccc43)cc2)cc1]

The content percentage of the charge transport substance in the charge transport layer is preferably 25% to 70% by mass and more preferably 30% to 55% by mass in relation to the total mass of the electron transport layer.

Examples used for charge transport layers may include a polyester resin, a polycarbonate resin, a (meth)acrylic resin, a polystyrene resin, and the like. Among them, a polycarbonate resin and a polyester resin are preferable. As polyester resins, a polyarylate resin is particularly preferable. A polycarbonate resin preferably has a structural unit represented by the formula (E) below and a structural unit represented by the formula (F) below.

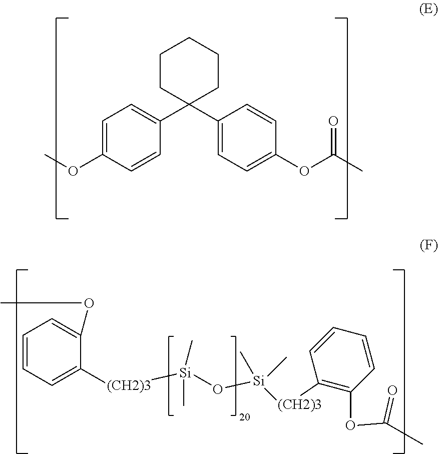

When the charge transport layer is formed as a surface layer, a binder resin that can be used for the surface layer described above may be used.

The content ratio (mass ratio) between the charge transport substance and the resin in the charge transport layer is preferably 4:10 to 20:10 and more preferably 5:10 to 12:10.

The charge transport layer may contain additives such as an antioxidant, a UV ray absorber, a plasticizer, a leveling agent, a slipperiness-imparting agent, and a wear resistance-improving agent. Specific examples of additives may include a hindered phenol compound, a hindered amine compound, a sulfur compound, a phosphorous compound, a benzophenone compound, a siloxane-modified resin, silicone oil, a fluororesin particle, a polystyrene resin particle, a polyethylene resin particle, a silica particle, an alumina particle, a boron nitride particle, and the like.

The arithmetic average film thickness of the charge transport layer is preferably 5 to 50 μm, more preferably 8 to 40 μm, and particularly preferably 10 to 30 μm.

The charge transport layer may be formed by preparing a coating solution for charge transport layers containing the materials described above and a solvent, forming a coated film of this coating solution, and curing the coating solution by heating and drying or the like. Examples of solvents used in the coating solution may include alcohol-type solvents, ketone-type solvents, ether-type solvents, ester-type solvents, and aromatic hydrocarbon-type solvents. Among these solvents, at least one selected from the group consisting of an ether-type solvent and an aromatic hydrocarbon-type solvent is preferable.

### (2) Monolayer-Type Photosensitive Layer

The monolayer-type photosensitive layer contains a charge generation substance and a charge transport substance. It is preferable that the monolayer-type photosensitive layer further contains a resin. When the electrophotographic photoreceptor does not have a protective layer, the monolayer-type photosensitive layer corresponds to the surface layer of the electrophotographic member, and layers other than the monolayer-type photosensitive layer correspond to the base layer of the electrophotographic member.

The monolayer-type photosensitive layer may be formed by preparing a coating solution for photosensitive layers containing a charge generation substance, a charge transport substance, a solvent, and the like, forming a coated film of this coating solution, and curing the coating solution by heating and drying or the like. As charge generation substances, charge transport substances, resins, and solvents, the materials described in the above “(1) Laminated-type Photosensitive Layer” section can be used.

### Protective Layer

The electrophotographic photoreceptor may have a protective layer on the photosensitive layer. When the electrophotographic photoreceptor has a protective layer, the photosensitive layer is covered with a protective layer, and the photosensitive layer can be protected from scraping. As a result, the durability of the electrophotographic photoreceptor can be improved. It is preferable that the protective layer contains a resin. Furthermore, the protective layer has a surface layer. When the protective layer is formed as a surface layer, a binder resin that can be used for the surface layer described above may be used.

When the protective layer is formed as a surface layer, the protective layer contains the binder resin described above and a tin oxide-containing particle.

The protective layer may contain a conductive filler. If the protective layer contains a conductive filler, a charge transport ability can be imparted to the protective layer. The material of the conductive filler is not particularly limited, and the tin oxide-containing particle described in the above section of the surface layer and the conductive filler described in the above section of the conductive layer.

The protective layer may contain additives such as an antioxidant, a UV ray absorber, a plasticizer, a leveling agent, and a slipperiness-imparting agent. Specific examples of additives may include a hindered phenol compound, a hindered amine compound, a sulfur compound, a phosphorous compound, a benzophenone compound, a siloxane-modified resin, silicone oil, a polystyrene resin particle, a polyethylene resin particle, a silica particle, an alumina particle, a boron nitride particle, and the like.

The arithmetic average film thickness of the protective layer is preferably 0.5 to 10 μm and more preferably 1 to 7 μm. Alternatively, the arithmetic average film thickness may be 2 to 10 μm.

The protective layer may be formed by preparing a coating solution for protective layers containing the materials described above and a solvent, forming a coated film of this coating solution, and curing the coating solution by heating and drying, electron beam irradiation, or the like. Examples of solvents used in the coating solution may include alcohol-type solvents, ketone-type solvents, ether-type solvents, sulfoxide-type solvents, ester-type solvents, and aromatic hydrocarbon-type solvents.

The surface resistivity of the surface layer of the electrophotographic photoreceptor when 100 V is applied is preferably 3.0×10⁹ to 1.0×10¹² Ω/sq, more preferably 3.0×10⁹ to 9.0×10¹¹ Ω/sq, further more preferably 3.0×10⁹ to 9.0×10¹¹ Ω/sq, and particularly preferably 7.0×10⁹ to 5.0×10¹¹ Ω/sq. When the surface resistivity is within the range, the occurrence of electrical discharging in the voltage-applying part is suppressed, and image defects due to deterioration of the photoreceptor surface layer originating from electrical discharging are easily prevented. For example, the surface resistivity may be adjusted by the amount of the tin oxide-containing particle. The way of measuring the surface resistivity will be described later.

### Process Cartridge

The electrophotographic photoreceptor of the present disclosure may be used in a process cartridge. In other words, the process cartridge is integrally provided with the electrophotographic photoreceptor of the present disclosure and at least one means selected from the group consisting of charging means, development means, transferring means, and cleaning means. It is preferable that the process cartridge is configured to be detachable to the body of the electrophotographic image forming apparatus.

### Electrophotographic Image Forming Apparatus

The electrophotographic member of the present disclosure may be used in an electrophotographic image forming apparatus. In other words, the electrophotographic image forming apparatus is provided with the electrophotographic photoreceptor of the present disclosure. As described above, the electrophotographic image forming apparatus has charging means, exposure means, development means, and transferring means.

FIG. 4 shows an example of a schematic cross-sectional configuration of an electrophotographic image forming apparatus with a process cartridge provided with an electrophotographic photoreceptor.

### Electrophotographic Belt

The electrophotographic member of the present disclosure may be used as an electrophotographic belt. In other words, the electrophotographic member may be an electrophotographic belt.

In this embodiment, an electrophotographic belt at least has a base layer 21 and a surface layer 22 on the base layer 21, as illustrated in FIG. 2. In other words, the electrophotographic belt can be said to be a laminated body. However, the electrophotographic belt may have layers other than these, and a primer layer for improving the adhesiveness between layers, a stress relief layer for suppressing the cracks in the surface layer 22, or an intermediate layer for suppressing bleeding objects may be added.

### Base Layer

The shape of the base layer 21 is not particularly limited and may be, for example, roll-shaped or belt-shaped, preferably cylindrical with an endless shape.

The material of the base layer 21 is not particularly limited, and, for example, the following may be mentioned. Resins such as polyether ether ketone, polyethylene terephthalate, polybutylene naphthalate, polyester, polyimide, polyamide, polyamide-imide, polyacetal, polyphenylene sulfide, and polyvinylidene fluoride, and the like. Among them, polyimide is preferable because environmental stability can be achieved.

The base layer 21 may contain conductive compounds such as metal powder, conductive oxide powder, conductive carbon, lithium salts, and ionic liquid to impart conductivity. Among them, the base layer preferably contains carbon black from the viewpoint of excellent conductivity and environmental stability. Combinations of other resins and conductive agents listed as examples may be used.

The base layer may be surface-treated to improve the adhesiveness with the surface layer. The way of surface treatment is not particularly limited, and, for example, corona treatment may be mentioned.

The film thickness of the base layer 21 is preferably 10 to 500 μm. If the film thickness is smaller than 10 μm, the mechanical strength may be lowered. If the film thickness is larger than 500 μm, the base layer 21 becomes rigid and may be difficult to use as an intermediate transfer member.

### Surface Layer

The surface layer 22 corresponds to the surface layer of the electrophotographic member described above. The surface layer 22 contains the binder resin described above, a tin oxide-containing particle, and at least one copolymer selected from the group consisting of a polyoxyethylene-polycaprolactone copolymer and a polyoxyethylene-polyvalerolactone copolymer.

### Volume Resistivity of Electrophotographic Belt

When the volume resistivity of the electrophotographic belt is high, the surface charge (residual charge) of the electrophotographic belt may be difficult to attenuate after the electrophotographic belt receives transfer charging by a secondary transfer member. In this case, the toner image on a photosensitive drum may be affected by the residual charge before the photosensitive drum and the electrophotographic belt come into contact during the next primary transfer, and a part of the toner image may be scattered when transferred onto the electrophotographic belt, resulting in the deterioration of image qualities. Furthermore, the residual charge on the electrophotographic belt may be irregular in some cases, causing irregular scattering, which may cause image irregularity.

From this viewpoint, when ρv1 is the volume resistivity of the electrophotographic belt, it is preferable that ρv1 satisfies the formula (2) below, and it is more preferable that ρv1 satisfies the formula (2-1) below. The ρv1 can be adjusted depending on the amount and dispersion state of the tin oxide-containing particle. The way of measuring ρv1 will be described later.

$$\begin{matrix}1. \times {10}^{8} Ω \cdot cm \leq ρ v 1 \leq 1. \times {10}^{12} Ω \cdot cm & ( 2 ) \\ 1. \times {10}^{8} Ω \cdot cm \leq ρ v 1 \leq 7. \times {10}^{11} Ω \cdot cm & ( 2 - 1 )\end{matrix}$$

When ρv2 is a volume resistivity measured after removing the surface layer from the electrophotographic member, it is preferable that ρv1 and ρv2 satisfy the formula (1) below, and it is more preferable that ρv1 and ρv2 satisfy the formula (1-1) below. ρv2 denotes the volume resistivity of a portion other than the surface layer of the electrophotographic belt. For example, when the electrophotographic belt is constituted of a base layer and a surface layer on the base layer, the volume resistivity of the base layer is shown. When ρv1 and ρv2 satisfy the formula (1) below, electric discharging in the voltage-applying part can be prevented. ρv1 can be adjusted by the conductive filler amount in the base layer and the conductive filler amount of the tin oxide-containing particle or the like in the surface layer. The way of measuring ρv2 will be described later.

$$\begin{matrix}0.5 \leq {log}_{10} ( ρ v 1 / ρ v 2 ) \leq 3.5 & ( 1 ) \\ 1. \leq {log}_{10} ( ρ v 1 / ρ v 2 ) \leq 2.5 & ( 1 - 1 )\end{matrix}$$

### Measurement Method of Arithmetic Average Film Thickness

Regarding the arithmetic average film thickness of each layer, for example, the arithmetic average film thickness of the surface layer can be determined by fitting the interference waveform in the wavelength range of 500 to 900 nm using an interferometric film thickness meter (trade name: F20; manufactured by Filmetrix Inc.) based on reflectance spectroscopy using software supplied with the meter.

### Evaluation of Dispersed State in Surface Layer of Tin Oxide-Containing Particle

In an L function indicating the relationship of the distribution of the tin oxide-containing particle observed from the surface of the surface layer, it is preferable that a value of the L function at a distance within the range of 300 nm to 1 μm from the center-of-gravity coordinate of the particle is always positive.

The evaluation method of the dispersed state of the tin oxide particle in the surface layer based on the L function is as follows.

The L function is described below. Ripley's K function is defined as follows.

$$K ( d ) = E / λ$$

In the formula, E denotes the number of points other than a randomly selected point in a circle of radius d centered at the randomly selected point. λ is the density (average density) of points in the entire region.

In other words, Ripley's K function, K(d), is a value obtained by dividing the average of the number of points other than a randomly selected point in a circle of radius d centered at the randomly selected point by the density (average density) of points in the entire region. When points are randomly scattered on a finite plane, the points follow a Poisson distribution. Here, when points are randomly distributed following a Poisson distribution, an expected value of the number of the other points existing in the circle of radius d is a value obtained by multiplying the average density X by the area πLd² of the circle and expressed as follows.

$$K ( d ) = π {d}^{2}$$

Here, the L function is a standardized linear function of Ripley's K function. The L function L(d) is expressed as follows.

$$L ( d ) = √ ( K ( d ) / π ) - d$$

Considering the L function as an index, L(d)=0 when points are randomly distributed, regardless of the radius d. When the spatial distribution is an aggregated distribution (clustered distribution), L(d) takes a positive value, and when the spatial distribution is a regular distribution (regularly spaced distribution), L(d) takes a negative value. In other words, with respect to a random distribution as a standard, L(d) takes a positive value if the number of other points within a certain radius d is larger than the random distribution, and L(d) takes a negative value if the number of other points within a certain radius d is smaller than the random distribution.

As the distribution state of tin oxide particles, the positive L function at a small radius d can be evaluated as that the number of tin oxide particles in close proximity is large. The dispersion diameter of tin oxide particles in the surface layer is normally distributed within the range of 300 nm to 1 km. Thus, in the present disclosure, the radius d is centered on the center-of-gravity coordinate of one particle (group) of interest, and the L-function is evaluated in a region where the distance from the center-of-gravity coordinate is within the range of 300 nm to 1 km.

Here, for example, when the dispersion diameter of tin oxide particle in the surface layer is 300 nm, a positive L function when the distance from the center-of-gravity coordinate is 300 nm to 1 μm means that the number of particles (particle groups) with the center-of-gravity coordinate within the range of 300 nm to 1 μm from the center-of-gravity coordinate of the particle (particle group) of interest is larger than the number in the case of random distribution. Hereinafter, the distance from the center-of-gravity coordinate may also be referred to as an interparticle distance.

Accordingly, the fact that the value of the L function, L(d), is always positive within the range of interparticle distance of 300 nm to 1 μm indicates that the tin oxide particles in the surface layer are distributed in the form of clusters within the range of interparticle distance of 300 nm to 1 km.

Incidentally, the surface layer containing tin oxide particles may be a dried film of a coated film of a coating composition that contains tin oxide-containing particles dispersed in a binder resin or raw materials thereof or a cured film of the coated film.

Then, in the surface layer formed using the paint containing tin oxide particles dispersed therein, the distribution state of the tin oxide particles depends on the dispersion state of tin oxide particles in the paint.

Normally, tin oxide particles in a paint are highly dispersed using a dispersing agent in order to prevent variations in the qualities of the coated film. Then, it is considered that the distribution state of tin oxide particles in the surface layer formed using such a paint is random, i.e., L(d)=0. It is also considered that the distribution state of tin oxide particles in the surface layer formed using a paint containing agglomerated tin oxide particles after being left for a long period of time is agglomerated at regular intervals, i.e., L(d)<0.

For determining the L function indicating the existing state of tin oxide particles in the surface layer, an evaluation sample is first prepared. A sample having a length of 5 mm, a width of 5 mm, and a thickness equivalent to the full thickness of the electrophotographic member is sampled from any part of the electrophotographic material.

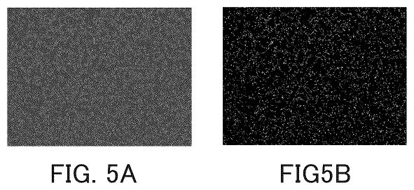

Subsequently, the surface of the surface layer was observed by scanning electron microscopy (SEM) (trade name: FE-SEM JSM-F100, manufactured by JEOL Ltd.) to acquire the backscattered electron image of the surface (FIG. 5A). The observation condition is the backscattered electron image mode at ×3,000, and the backscattered electron image acquisition conditions are an acceleration voltage of 5.0 kV and a working distance of 6 mm. A backscattered electron image provides much composition information, i.e., the larger the atomic number of an element, the brighter. Because tin oxide particles include tin atoms, whose atomic number is large, the brightness is observed brighter.

Next, binarizing processing is performed on the obtained image (42.7 μm×32.0 μm) using image processing software so that the portions of tin oxide particles are shown as white, and the portions of a (meth)acrylic resin other than tin oxide particles are shown as black (FIG. 5B). An image in which only the portions of tin oxide particles are extracted as white portions can be obtained by binarizing the image so that the fractions equivalent to the volume % (area %) of tin oxide-containing particles from the brightest side are made white and the others are made black. As image processing software, for example, “Image J” (distributed by the National Institutes of Health) may be used.

Specific conditions of binarizing are as follows. First, an SEM image is loaded into image processing software, and the SEM image is converted into a brightness image of 256 gradations. Next, binarizing processing for classifying the portions of tin oxide particles as white and the binder resin portions as black is performed. The threshold at this time is determined such that the occupancy area ratio of the white portions after binarization (the ratio of the number of pixels occupied by the white portions with respect to the total number of pixels in one sheet of an SEM image) matches with the content percentage of tin oxide particles. The content percentage of tin oxide particles in the surface layer can be calculated from the respective densities of a binder resin, tin oxide particles, and other additives, which are obtained from the respective mass percentages thereof determined by thermogravimetric analysis (TGA analysis) of the surface layer.

From the obtained binarized images, the values of the planar center-of-gravity coordinates (X coordinate and Y coordinate) and the number average particle diameter of the tin oxide particle are determined.

Specifically, for example, using the image processing software described above, the planar center-of-gravity coordinates of each particle are determined for the portions (white portions) of tin oxide particles in the binarized image using the “analyze” function.

Regarding the number average particle diameter, the circle-equivalent diameter of each particle is first calculated. The “circle-equivalent diameter of each particle” means the diameter of a circle with the same area as the particle. Specifically, the number of pixels constituting each particle is calculated, and an actual particle area is calculated by multiplying this number of pixels by the area per pixel.

In an SEM image used in the Examples described later, because the length of one side of one pixel was equivalent to 0.15 μm, the number of pixels constituting each particle was multiplied by 0.15×0.15 μm².

Then, a circle-equivalent diameter is calculated by determining the diameter of the circle having this area. The sum total of circle-equivalent diameters of particles thus obtained is divided by the total number of particles to calculate a number average dispersion diameter.

Next, Ripley's K function is calculated by the following formula from the values of the planar center-of-gravity coordinates (X coordinate and Y coordinate) of the tin oxide particle.

$$K ( d ) = \frac{1}{λ} ( \frac{1}{n} {\sum }_{i \neq j} \frac{1}{{w}_{t}} {I}_{d} ( i , j ) )$$

Here, i is an index indicating each particle in an image, λ is the average density of particles in the image, and n is the number of particles in the image. wᵢ is a ratio (area B/area A) between the “area A of the circle i of radius d centered at the center-of-gravity coordinates of a particle i” and the “area B of the portion of the circle i of radius d centered at the center-of-gravity coordinates of a particle i included in the image”. wᵢ is for correcting underestimation due to the absence of particles outside the image when a particle i is present in the proximity of the border of the image. I_{d}(i, j) is a function taking 1 if the center-of-gravity coordinates of the particle j are in a circle of radius d centered at the center-of-gravity coordinates of the particle i and taking 0 in the other cases. In the present disclosure, the radius d is a discrete function that takes values pixel by pixel (0.033 μm) of the image.

Next, the value L(d) of the L function was determined within the range of interparticle distance d (radius d) of 300 nm to 1 μm by the following formula from Ripley's K function.

$$L ( d ) = \sqrt{\frac{K ( d )}{π}} - d$$

The fact that the value of the L function is always positive within the range of interparticle distance of 300 nm to 1 μm indicates that the L(d) described above becomes always positive within the range of interparticle distance of 300 nm to 1 μm.

Within the range where the radius d is smaller than the minimum dispersion diameter of tin oxide particles, other tin oxide particles cannot exist, and, therefore, the value of the L function, L(d), becomes negatively large.

To ensure that the value of the L function is always positive within the range of interparticle distance of 300 nm to 1 μm, it is effective to incorporate a (meth)acrylic resin and a copolymer with a specific structure.

Within the range of interparticle distance of 300 nm to 1 μm, the maximum value of the L function is preferably 0.3 or more, more preferably from 0.3 to 5.0, and further preferably from 0.3 to 2.0. For example, within the range of interparticle distance of 300 nm to 1 μm, it is preferable that the value of the L function is always over 0 and 5.0 or less, or within the range of 0.3 to 5.0 or 0.3 to 2.0.

### Electrophotographic Image Forming Apparatus

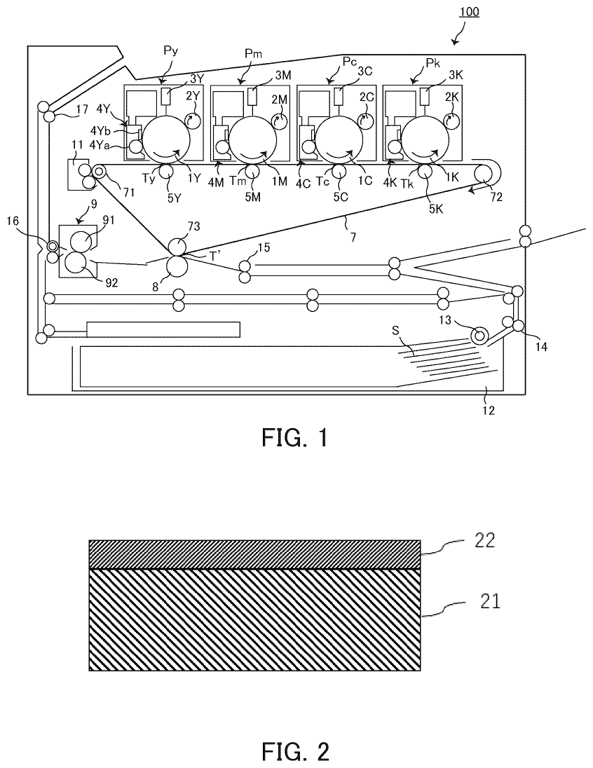

The electrophotographic image forming apparatus 100 illustrated in FIG. 1 is a schematic cross-sectional view of an electrophotographic image forming apparatus provided with an electrophotographic member according to one aspect of the present disclosure.

The electrophotographic image forming apparatus 100 illustrated in FIG. 1 is provided with an intermediate transfer belt (electrophotographic belt) 7, which is an intermediate transfer member. Along the flat portion of the intermediate transfer belt 7, image forming units Py, Pm, Pc, and Pk for yellow (Y), magenta (M), cyan (C), and black (K) colors, respectively, are arranged in order in the moving direction of the intermediate transfer belt 7. In the FIG. 1, 1Y, 1M, 1C, and 1K each represent an electrophotographic photoreceptor, and 2Y, 2M, 2C, and 2K each represent a charge roller. 3Y, 3M, 3C, and 3K each denote a laser exposure device, 4Y, 4M, 4C, and 4K each denote a developing device, and 5Y, 5M, 5C, and 5K each denote a primary transfer roller. Because the basic configuration of each image forming unit is the same, the details of image forming units are described only for the yellow image forming unit Py.

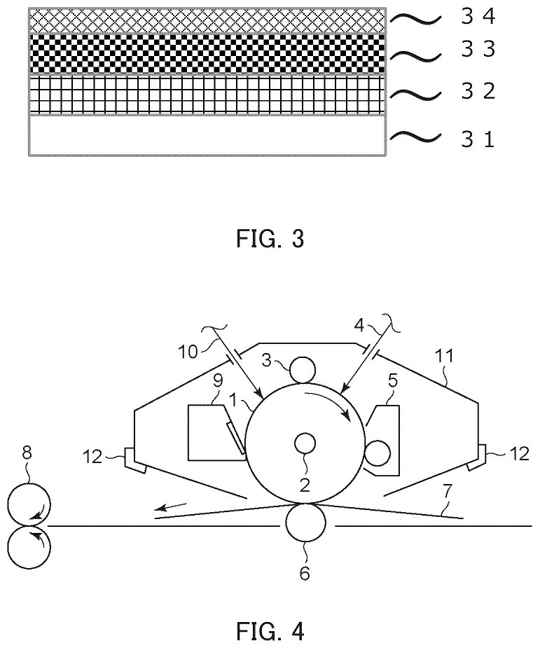

The yellow image forming unit Py has a drum-type electrophotographic photoreceptor (hereinafter also referred to as a “photosensitive drum” or a “first image bearing member”) 1Y as an image bearing member. The photosensitive drum 1Y is formed by sequentially laminating a charge generation layer, a charge transport layer, and a surface protection layer on the substrate of an aluminum cylinder. FIG. 3 shows an example of a cross-sectional view of the photosensitive drum. In the figure, 31 is the aluminum cylinder, 32 is a charge generation layer, 33 is a charge transport layer, and 34 is a surface protection layer.

The yellow image forming unit Py is provided with a charge roller 2Y as charge means. The surface of the photosensitive drum 1Y is uniformly charged by applying a charging bias to the charge roller 2Y.

Above the photosensitive drum 1Y, a laser exposure device 3Y as image exposure means is installed. The laser exposure device 3Y performs scanning exposure on the surface of the uniformly charged photosensitive drum 1Y according to the image information and forms an electrostatic latent image of the yellow color component on the surface of the photosensitive drum 1Y.

The electrostatic latent image formed on the photosensitive drum 1Y is developed with a toner, which is a developer, by a developing device 4Y as developing means. The developing device 4Y includes a developing roller 4Ya, which is a developer carrier, and a regulating blade 4Yb, which is a developer amount regulating member, and contains a yellow toner, which is a developer. The developing roller 4Ya to which the yellow toner is supplied is lightly compressed against the photosensitive drum 1Y in the developing section and is rotated with a speed difference in the forward direction from the photosensitive drum 1Y. The yellow toner conveyed to the developing section by the developing roller 4Ya adheres to the electrostatic latent image formed on the photosensitive drum 1Y by applying a developing bias to the developing roller 4Ya. As such, a visible image (yellow toner image) is formed on the photosensitive drum 1Y.

The intermediate transfer belt 7 is stretched over a driver roller 71, a tension roller 72, and a driven roller 73 and comes into contact with the photosensitive drum 1Y to be moved (rotary driven) in the direction of the arrow in the figure. FIG. 2 shows an example of a cross-sectional view of the intermediate transfer belt. In the figure, 21 is the base layer, and 22 is the surface protection layer.

The yellow toner image formed on the photosensitive drum (on the first image bearing member) that has reached the primary transfer section Ty is primarily transferred onto the intermediate transfer belt 7 by the primary transfer element (primary transfer roller 5Y) that is disposed to face the photosensitive drum 1Y via the intermediate transfer belt 7.

Similarly, imaging operations stated above are performed in the units Pm, Pc, and Pk for magenta (M), cyan (C), and black (K), respectively, following the movement of the intermediate transfer belt 7, thereby stacking four-color toner images (yellow, magenta, cyan, and black) on the intermediate transfer belt 7. Toner layers of four colors are conveyed following the movement of the intermediate transfer belt 7, and, in the secondary transfer section T″ a secondary transfer roller 8 as secondary transfer means transfers the toner layers in a batch onto a transfer material S (hereinafter also referred to as a “second image bearing member”) conveyed at a predetermined timing.

In such a secondary transfer, a transfer voltage of several kilovolts is normally applied to ensure a sufficient transfer rate.

The transfer material S is supplied by a pickup roller 13 from a cassette 12 that contains the transfer material S to a conveyance path. The transfer material S supplied onto the conveyance path is synchronized with the four-color toner image transferred to the intermediate transfer belt 7 by a conveyance roller pair 14 and a resist roller pair 15 and is conveyed to the secondary transfer section T′.

The toner image transferred to the transfer material S is fixed by the fixing unit 9 to form, for example, a full-color image. The fixing unit 9 has a fixing roller 91 with heating means and a pressure roller 92 and fixes an unfixed toner image on the transfer material S by heating and pressurizing. After that, the transfer material S is discharged to the outside of the apparatus by a conveyance roller pair 16, a discharge roller pair 17, and the like.

As described above, electrical transfer processes of toner images from the photoreceptor to the intermediate transfer belt, and from the intermediate transfer belt to the transfer material are repeated. In addition, repeated recording on a large number of transfer materials results in further repetition of the electrical transfer processes.

### EXAMPLES

Hereinafter, the present invention will be described in more detail with reference to Examples and Comparative Examples. The present disclosure is not limited at all by the following Examples as long as they do not exceed the gist thereof. In the Examples below, the “part(s)” is/are mass basis unless otherwise noted.

### Production Example of Copolymer β1

The following three compounds were mixed under a nitrogen atmosphere to cause a reaction at 180° C. for 8 hours while stirring, thereby preparing a hydroxy group-containing poly(ε-caprolactone)-polyoxyethylene copolymer α1.

| | |
|---|---|
| Alcohol ethoxylate | 41 parts by mass |
| (trade name: Genapol C100; | |
| manufactured by Clariant AG) | |
| ϵ-Caprolactone (manufactured by Tokyo | 31 parts by mass |
| Chemical Industry Co., Ltd.) | |
| Dibutyltin dilaurate (manufactured by Tokyo | 0.005 parts by mass |
| Chemical Industry Co., Ltd.) | |

The structural formula of “Genapol C100” is as follows.

HO—(CH₂CH₂O)n-(CH₂)m-CH₃

(n=10 and m=11 or 17)

The resulting hydroxy group-containing poly(F-caprolactone)-polyoxyethylene copolymer al and phosphoric acid were mixed in the following proportions and reacted at 80° C. for 6 hours while stirring. During the reaction, water was removed using molecular sieves 3A. The reaction yielded a copolymer, poly(F-caprolactone)-polyoxyethylene copolymer β1, which contained a phosphate group.

| | |
|---|---|
| α1 | 100 parts by mass |
| Phosphoric acid (concentration: 89% | 15 parts by mass |
| by mass or more, manufactured by Tokyo | |
| Chemical Industry Co., Ltd.) | |

### Production Example of Copolymer β2

A copolymer β2 was prepared in the same manner as in the Production Example of the copolymer β1, except that ε-caprolactone was changed to γ-valerolactone, and the amount of the γ-valerolactone was changed to 18 parts by mass.

### Production Example of Copolymer β3

A copolymer α3 was prepared in the same manner as in the copolymer α1, except that Genapol C100 was changed to polyoxyethylene (4) lauryl ether (manufactured by Kao Corporation, EMULGEN 104P), ε-caprolactone was changed to Δ-valerolactone, and the amount of the A-valerolactone was changed to 22 parts by mass.

The copolymer α3 was dissolved in ion-exchanged water with an electrical conductivity of 10 μS/cm or less to prepare a 20-mass % solution of the copolymer α3. To 100 parts by mass of this solution, 1 part by mass of 5 mass % platinum catalyst (manufactured by Evonik Industries AG, trade name: PMPC SP2010W 5% Pt on activated carbon, water wet) was added, and the resulting mixture was placed under nitrogen reflux in a three-necked flask. After that, the mixture was heated to 70° C. in a water bath and kept at the same temperature for 15 minutes, and oxygen was flown into the system at a flow rate of 90 mL/min to cause a reaction for 18 hours. After that, oxygen was switched to nitrogen, and catalysts were removed by filtration. After the evaporation of water, which was a solvent, a poly(F-caprolactone)-polyoxyethylene copolymer β3 was prepared.

### Production Example of Copolymer β4

A copolymer β4 was prepared in the same manner as the copolymer β1, except that the amount of ε-caprolactone was changed to 77 parts by mass.

### Measurement of Properties of Copolymer

1H-NMR of copolymers β1 to β4 was measured using a 400-MHz NMR (JNM-ECA400 II), manufactured by JEOL, then the measurement results were each analyzed, and the number average molecular weight and the proportion of the PEG units in a molecule were calculated.

The details of the measurement method will be described with reference to the copolymer β1 as an example. The copolymer β1 was dissolved in a TMS-containing deuterated chloroform solvent (manufactured by Tokyo Chemical Industry Co., Ltd.), and 1H-NMR was measured. Peak attribution was performed based on a TMS-derived peak, and from the 1H-NMR, the area ratios of hydrogen atoms corresponding to the terminal hydrocarbons, hydrogen atoms corresponding to PEG units, and hydrogen atoms corresponding to polycaprolactone units were determined. The p, n, and m in the formula (G) below were calculated based on the area ratios, and the number average molecular weight and the proportion of PEG units in one molecule of the copolymer β31 were calculated.

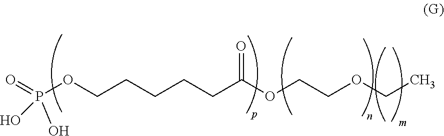

Table 1 shows the type of raw materials, the amount added, and the properties of the copolymer β1 to β4.

TABLE 1

| | Raw material | | | | | Properties | |
|---|---|---|---|---|---|---|---|
| | | | | | | | Content percentage |
| | Hydroxy PEG | | Cyclic ester | | | | (% by mass) |
| | | Parts | | Parts | Functional | Molecular | of POE units |
| | Type | by mass | Type | by mass | group | weight | in copolymer |
| Copolymer β1 | Genapol C100 | 41 | ε-Caprolactone | 31 | Phosphate | 1100 | 40% |
| Copolymer β2 | Genapol C100 | 41 | γ-Valerolactone | 18 | Phosphate | 900 | 49% |
| Copolymer β3 | Polyoxyethylene (4) | 41 | Δ-Valerolactone | 22 | Carboxy | 600 | 29% |
| | lauryl ether | | | | | | |
| | (EMULGEN 104P) | | | | | | |
| Copolymer β4 | Genapol C100 | 41 | ε-Caprolactone | 77 | Phosphate | 2000 | 22% |

In the Table, the POE units mean polyoxyethylene units.

### Production Example of Dispersing Liquid γ1

The materials listed below were put in a glass standard bottle and dispersed for four hours with a paint shaker manufactured by Toyo Seiki Seisaku-Sho, Ltd., and the resulting mixture was filtrated through a nylon mesh with 60 μm opening to prepare a dispersing liquid γ1.

| | |
|---|---|
| Antimony-doped tin oxide (manufactured | 40 parts by mass |
| by Mitsubishi Materials Electronic | |
| Chemicals Co., Ltd.) | |
| Poly(ϵ-caprolactone)-polyoxyethylene | 1.2 parts by mass |
| copolymer β1 | |
| 2-Propanol (manufactured by Kishida | 30 parts by mass |
| Chemical Co., Ltd.) | |
| 1,1,2,2-Tetrafluoroethyl 2,2,2-trifluoroethyl | 30 parts by mass |
| ether (trade name: AE-3000, | |
| manufactured by AGC Inc.) | |
| φ0.8 mm Glass beads | 30 parts by mass |

### Production Examples of Dispersing Liquids γ2 to 4 and Dispersing Liquids γS1 to γS3

Dispersing liquids γ2 to γ4 and dispersing liquids γS1 to γS3 were prepared in the same manner as the dispersing liquid γ1, except that the type of the conductive filler and additives were changed to those listed in Table 2. Here, the following materials were used.

Phosphorous-doped tin oxide: manufactured by Mitsubishi Materials Electronic Chemicals Co., Ltd.
Octadecyl phosphate: manufactured by ALFA Chemistry
1-Decanol: manufactured by Tokyo Chemical Industry Co., Ltd.
Polyvinyl alcohol: Mn (number average molecular weight)=20,000, manufactured by Sigma-Aldrich Co. LLC

TABLE 2

| | Conductive filler | Type of Additive |
|---|---|---|
| Dispersing liquid γ1 | Antimony-doped tin oxide | Copolymer β1 |
| Dispersing liquid γ2 | Antimony-doped tin oxide | Copolymer β2 |
| Dispersing liquid γ3 | Phosphorous-doped tin oxide | Copolymer β3 |
| Dispersing liquid γ4 | Antimony-doped tin oxide | Copolymer β4 |
| Dispersing liquid γS1 | Antimony-doped tin oxide | Octadecyl phosphate |
| Dispersing liquid γS2 | Antimony-doped tin oxide | 1-Decanol |
| Dispersing liquid γS3 | Antimony-doped tin oxide | Polyvinyl alcohol |

### Production Example of Paint A1

The following materials were mixed using a magnetic stirrer to prepare a paint A1.

| | |
|---|---|
| A mixture of pentaerythritol triacrylate and | 70 parts by mass |
| pentaerythritol tetraacrylate (trade name: | |
| M306, manufactured by Toagosei Co., Ltd.) | |
| 1,1,2,2-Tetrafluoroethyl 2,2,2-trifluoroethyl | 50 parts by mass |
| ether (trade name: AE-3000, | |
| manufactured by AGC Inc.) | |
| 2-Propanol (manufactured by | 50 parts by mass |
| Kishida Chemical Co., Ltd.) | |
| Dispersing liquid γ1 | 40 parts by mass |

### Production Examples of Paints A2 to A4 and Paints AS1 to AS4

Paints A2 to A4 and paints AS1 to AS4 were prepared in the same manner as the paint A1, except that the type of monomers and dispersing liquid, and the amount of the dispersing liquid added were changed to those listed in Table 3. Here, the following materials were used.
Urethane acrylate: trade name U-6LPA, manufactured by Shin-Nakamura Chemical Co., Ltd.

TABLE 3

| | | | Net |
|---|---|---|---|
| | | | weight of |
| | | | dispersing |
| | | Dispersing | liquid (parts |
| | Monomer | liquid | by mass) |
| Paint A1 | Mixture of pentaerythritol triacrylate | γ1 | 40 |
| | and pentaerythritol tetraacrylate | | |
| Paint A2 | Mixture of pentaerythritol triacrylate | γ2 | 40 |
| | and pentaerythritol tetraacrylate | | |
| Paint A3 | Mixture of pentaerythritol triacrylate | γ3 | 20 |
| | and pentaerythritol tetraacrylate | | |
| Paint A4 | Urethane acrylate U-6LPA | γ4 | 105 |
| Paint AS1 | Mixture of pentaerythritol triacrylate | γS1 | 40 |
| | and pentaerythritol tetraacrylate | | |
| Paint AS2 | Mixture of pentaerythritol triacrylate | γS2 | 40 |
| | and pentaerythritol tetraacrylate | | |
| Paint AS3 | Mixture of pentaerythritol triacrylate | γS3 | 40 |
| | and pentaerythritol tetraacrylate | | |
| Paint AS4 | Mixture of pentaerythritol triacrylate | γS1 | 170 |
| | and pentaerythritol tetraacrylate | | |

### Example A1 As a conductive support, an aluminum cylinder with a diameter of 30 mm, a

length of 357.5 mm, and a wall thickness of 1 mm was prepared.

Next, 100 parts of zinc oxide particles (specific surface area: 19 m²/g, powder resistance: 4.7×10⁶ Ω·cm) as conductive particles were stirred and mixed with 500 parts of toluene, 0.8 parts of a silane coupling agent (compound name: N-2-(aminoethyl)-3-aminopropylmethyldimethoxysilane, trade name: KBM602, manufactured by Shin-Etsu Chemical Co., Ltd.) was added thereto, and the resulting mixture was stirred for 6 hours. After that, toluene was removed under reduced pressure, and the residue was dried under heating at 130° C. for 6 hours to prepare surface-treated zinc oxide particles.

Next, 15 parts of a polyvinyl butyral resin (trade name: BM-1, manufactured by Sekisui Chemical Co., Ltd.) and 15 parts of a blocked isocyanate (trade name: Sumidur 3175, manufactured by Sumitomo Bayer Urethane Co., Ltd.) were dissolved in a mixed solution of 73.5 parts of methyl ethyl ketone and 73.5 parts of 1-butanol to prepare a solution.

To the resulting solution, 80.64 parts of the above surface-treated zinc oxide particle and 0.8 parts of a compound represented by the formula (A) below (manufactured by Tokyo Chemical Industry Co., Ltd.) were added, the resulting mixture was dispersed for 3 hours under the atmosphere of 23° C.±3° C. using a sand mill device with glass beads having a diameter of 0.8 mm.

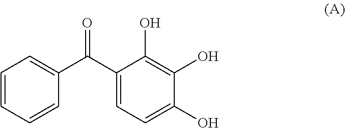 [SMILES: O=C(c1ccccc1)c1ccc(O)c(O)c1O]

After dispersion, 0.01 parts of silicone oil (trade name: SH28PA, manufactured by Dow Corning Toray Silicone Co., Ltd.) and 5.6 parts of closslinkable poly(methyl methacrylate) (PMMA) particles (trade name: TECHPOLYMER SSX-103, manufactured by Sekisui Plastics Co., Ltd., average primary particle diameter: 3.1 μm) were added and stirred to prepare a coating solution for undercoating layers.

This coating solution for undercoating layers was dip-coated on the above conductive support to form a coated layer, and the coated layer was heated and dried at 145° C. for 40 minutes, thereby forming an undercoating layer with an arithmetic average film thickness of 18 μm.

Next, 11 parts of gallium phthalocyanine hydroxide crystal in the form of crystals having strong peaks at Bragg angles (2θ0.2°) of 7.4° and 28.2° in the CuKα characteristic X-ray diffraction as a charge generation substance, 5 parts of polyvinyl butyral (trade name: S-LEC BX-1, manufactured by Sekisui Chemical Co., Ltd.), and 130 parts of cyclohexanone were mixed, then 500 parts of glass beads with a diameter of 1 mm were added thereto, and the resulting mixture was dispersed for 2 hours at a condition of 1,800 rpm while cooling with cooling water of 18° C.

After the dispersion treatment, 300 parts of ethyl acetate and 160 parts of cyclohexanone were added for dilution to prepare a coating solution for charge generation layers. This coating solution for charge generation layers was dip-coated on the undercoating layer, and the resulting coated film was dried at 110° C. for 10 minutes, thereby forming a charge generation layer with an arithmetic average film thickness of 0.16 μm.

The average particle diameter (median) of gallium phthalocyanine hydroxide crystals in the prepared coating solution for charge generation layers was 0.18 μm when measured using a centrifugal particle size analyzer (product name: CAPA 700, manufactured by HORIBA, Ltd.) based on the liquid phase sedimentation method.

Next, a coating solution for charge transport layers was prepared by dissolving 2 parts of the charge transport substance represented by the formula (B) below, 7 parts of a charge transport substance represented by the formula (C) below, 1 part of a charge transport substance represented by the formula (D) below, 10 parts of polycarbonate (trade name: Iupilon Z400, manufactured by Mitsubishi Gas Chemical Co., Ltd.), and 0.002 parts of a polycarbonate A having structural units represented by the formula (E) below and structural units represented by the formula (F) below (viscosity average molecule weight Mv: 20,000) in 70 parts of monochlorobenzene and 30 parts of dimethoxymethane. Here, in the polycarbonate A, the ratio (molar ratio) of the structural unit represented by the formula (E) below to the structural unit represented by the formula (F) below is 95/5.

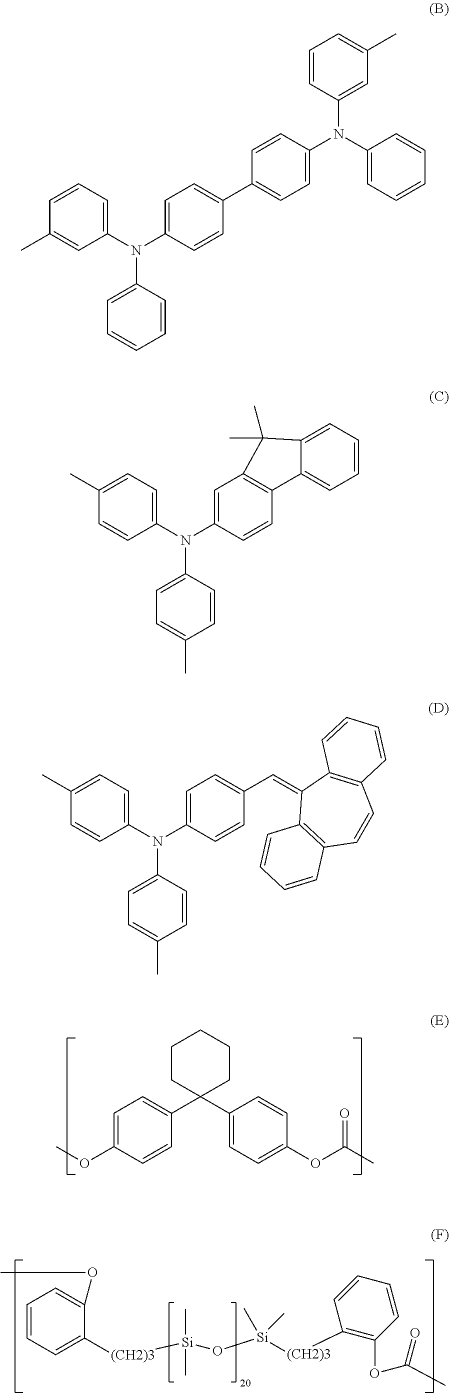

This coating solution for charge transport layers was dip-coated on the charge generation layer, and the resulting coated film was dried at 100° C. for 30 minutes, thereby forming a charge transport layer with an arithmetic average film thickness of 18 m. In these Examples, layers consisting of the conductive support, the undercoating layer, the charge generation layer, and the charge transport layer correspond to the base layer.

Subsequently, the paint A1 was dip-coated on this charge transport layer and heat-treated at 50° C. for 5 minutes. After that, the coated film was irradiated with an electron beam for 1.6 seconds under a nitrogen atmosphere in a condition of an acceleration voltage of 70 kV and an absorbed dose of 50 kGy. After that, the coated film was heat-treated for 25 seconds under a nitrogen atmosphere in a condition such that the coated film was 130° C. The oxygen concentration from the irradiation with an electron beam to the 25-second heat treatment was 20 ppm. Next, the coated film was heat-treated for 12 minutes in a condition such that the coated film was 115° C. to form a surface layer with an arithmetic average film thickness of 5 μm and prepare a photoreceptor A1.

### Examples A2 to A6 and Comparative Examples AS1 to AS4

Photoreceptors A2 to A6 and photoreceptors AS1 to AS4 were prepared in the same manner as in Example A1, except that the paint indicated in Table 4 was used instead of the paint A1 and the thickness was set to that indicated in Table 4.

Evaluation of Surface Resistivity The surface layer was formed on a 50-μm Lumirror film in the same manner as in Examples A1 to A6 and Comparative Examples AS1 to AS4, respectively, and the surface resistivity was measured in accordance with JIS K 6911 with a UR probe using Hiresta-UX (manufactured by Mitsubishi Chemical Analytech Co., Ltd.) while applying the voltage of 100 V between electrodes. Table 4 shows the results.

### Evaluation of Residual Potential

The residual potential was evaluated in the condition below on the photoreceptors of Examples A1 to A6 and Comparative Examples AS1 to AS4 prepared as above.

Using a photoreceptor test device (trade name: CYNTHIA59, manufactured by Gentec Electro-Optics, Inc.), the conditions of a charging device were first set such that the surface of the electrophotographic photoreceptor should be −700 V under the environment at a temperature of 23° C. and 50% RH. The electrophotographic photoreceptor was irradiated with a monochromatic light with a wavelength of 780 nm in an amount of light required to reduce the potential of −700 V to −200 V. Furthermore, the potential of the photoreceptor when irradiated with light in an amount of light of 20 (μJ/cm²) was measured, and the measured value was taken as a residual potential (−V). Table 4 shows the evaluation results.

### Evaluation of Durability of Images

A copier (trade name: iR ADVANCE C5560F, manufactured by Canon Inc.) was used as an electrophotographic device, then an image was formed by letters with a letter size of 5 points (1.764 mm square), and the image was visually evaluated to see if any blurred or blotchy areas were detected. Printing was evaluated on the image on the 100,000th sheets obtained after the process of 10,000 prints of A4 size paper, then suspending the power supply to the copier for 12 hours, and making 10,000 prints again was repeated to complete 100,000 prints. Table 4 shows the evaluation results.

Evaluation on Dispersion State of Tin Oxide Particle by L Function Evaluation samples were prepared from an electrophotographic belt. Samples having a length of 5 mm, a width of 5 mm, and a thickness equivalent to the full thickness of the electrophotographic belt were sampled from 12 locations of the electrophotographic belt. The sampling locations included three points in the width direction of the electrophotographic belt and four points every 900 in the circumferential direction. One of the three points in the width direction was set to a position where the center in the width direction matched with the center in the width direction of the evaluation sample. The other two points were set to positions where the points 2 mm inward (the midpoint side) from both ends in the width direction matched one end in the width direction of the sample.

Subsequently, any position of the surface corresponding to the outer surface (the surface opposite to the surface on the side facing the base layer) of each of the twelve evaluation samples was observed by scanning electron microscopy (SEM) (trade name: FE-SEM S-4800, manufactured by Hitachi High-Tech Corporation) to acquire an SEM image with a size of 42.7 μm in length×32.0 μm in width. The observation condition was the backscattered electron image mode at ×3000, and the backscattered electron image acquisition conditions were an acceleration voltage of 5.0 kV and a working distance of 6 mm. In the resulting SEM image, portions of tin oxide particles (tin oxide particle group) were observed to be bright.

Next, binarizing processing was performed on the obtained SEM image using image processing software (name: Image J; distributed by the National Institutes of Health) so that the portions of tin oxide particles should be shown as white, and the portions of the binder resin should be shown as black. An image in which only the tin oxide particles were extracted as white portions can be obtained by binarizing the image so that the fractions equivalent to the volume % (area %) of tin oxide particles from the brightest side were made white, and the others were made black.

Specific conditions of binarizing were as follows: First, an SEM image was loaded into image processing software, and the SEM image was converted into a grayscale brightness image of 256 gradations. Next, binarizing processing for classifying the portions of tin oxide particles as white and the binder resin portions as black was performed. The threshold at this time was determined such that the occupancy area ratio of the white portions after binarization (the ratio of the number of pixels occupied by the white portions with respect to the total number of pixels in one sheet of an SEM image) matched with the content percentage of tin oxide particles.

From the obtained binarized images, the values of the planar center-of-gravity coordinates (X coordinate and Y coordinate) and the number average particle diameter of the tin oxide particles (tin oxide particle group) were determined. Specifically, using the image processing software described above, the planar center-of-gravity coordinates of each particle were determined for the portions (white portions) of tin oxide particles in the binarized image.

Regarding the number average particle diameter, the circle-equivalent diameter of each particle was first calculated. The “circle-equivalent diameter of each particle” means the diameter of a circle with the same area as the particle. Specifically, the number of constituent pixels for each particle (particle group) was calculated, and an actual particle area was calculated by multiplying this number of pixels by the area per pixel. In the SEM image described above, the length of one side of one pixel was equivalent to 0.15 μm, and, therefore, the number of pixels constituting each particle was multiplied by 0.15×0.15 μm²

Then, a circle-equivalent diameter was calculated by determining the diameter of the circle with this area. The sum total of circle-equivalent diameters of particles thus obtained was divided by the total number of particles to calculate a number average dispersion diameter.

Next, Ripley's K function was calculated by the following formula from the values of the planar center-of-gravity coordinates (X coordinate and Y coordinate) of the tin oxide particle.

$$K ( d ) = \frac{1}{λ} ( \frac{1}{n} {\sum }_{i \neq j} \frac{1}{{w}_{t}} {I}_{d} ( i , j ) )$$

In the formula, i is an index indicating each particle in an image, λ is the average density of particles in the image, and n is the number of particles in the image. wᵢ is a ratio (area B/area A) between the “area A of the circle i of radius d centered at the center-of-gravity coordinates of a particle i” and the “area B of the portion of the circle i of radius d centered at the center-of-gravity coordinates of a particle i included in the image”. wᵢ is for correcting underestimation due to the absence of particles outside the image when a particle i is present in the vicinity of the border of the image. I_{d}(i, j) is a function taking 1 if the center-of-gravity coordinates of the particle j is in a circle of radius d centered at the center-of-gravity coordinates of the particle i and taking 0 in the other cases. In the present disclosure, the radius d is a discrete function that takes values pixel by pixel (0.033 μm) of the image.

Next, the value L(d) of the L function was determined within the range of interparticle distance d (radius d) of 300 nm to 1 μm by the following formula from Ripley's K function.

$$L ( d ) = \sqrt{\frac{K ( d )}{π}} - d$$

The fact that the value of the L function is always positive within the range of interparticle distance of 300 nm to 1 μm indicates that the L(d) described above becomes always positive within the range of interparticle distance of 300 nm to 1 μm.

All L functions indicating the distribution state of tin oxide particles (tin oxide particle group) obtained by analyzing an SEM image produced from each of the twelve evaluation samples by the above method were positive within the range of interparticle distance of 300 nm to 1 μm. Table 4 shows the results. In Table 4, which indicates the evaluation results described later, the evaluation of “positive” in the item of “positive or negative of L function (interparticle distance of 300 nm to 1 μm)” means that all L functions determined from the above analysis of twelve evaluation samples were positive within the range of interparticle distance of 300 nm to 1 μm. In contrast, the evaluation of “negative” in the same item means that at least one L function determined from the above analysis of twelve evaluation samples was negative within the range of interparticle distance of 300 nm to 1 μm.

When the L function was measured using an electrophotographic photoreceptor as a measurement target, an evaluation sample was prepared similarly to the electrophotographic belt, and then the L function was measured.

TABLE 4

| | | | Content percentage | Surface | Residual | | |
|---|---|---|---|---|---|---|---|
| | | Thickness | of particles | resistivity | potential | Image after | L |
| | Paint | (μm) | (vol %) | (Ω/sq.) | (V) | 100,000 prints | function |
| Example A1 | Paint A1 | 5 | 3.9 | 2.0 × 10¹⁰ | 38 | No blur and blotch | Positive |
| Example A2 | Paint A2 | 5 | 3.9 | 3.0 × 10¹⁰ | 41 | No blur and blotch | Positive |
| Example A3 | Paint A3 | 5 | 2.0 | 1.0 × 10¹⁰ | 35 | No blur and blotch | Positive |
| Example A4 | Paint A4 | 5 | 10.0 | 3.0 × 10⁹ | 45 | No blur and blotch | Positive |
| Example A5 | Paint A1 | 2 | 3.9 | 1.0 × 10¹¹ | 35 | No blur and blotch | Positive |
| Example A6 | Paint A1 | 10 | 3.9 | 1.0 × 10¹⁰ | 45 | No blur and blotch | Positive |
| Comparative | Paint AS1 | 5 | 3.9 | 2.0 × 10¹² | 81 | No blur and blotch | Negative |
| Example AS1 | | | | | | | |
| Comparative | Paint AS2 | 5 | 3.9 | 3.0 × 10¹² | 86 | No blur and blotch | Negative |
| Example AS2 | | | | | | | |
| Comparative | Paint AS3 | 5 | 3.9 | 1.0 × 10¹² | 81 | No blur and blotch | Negative |
| Example AS3 | | | | | | | |
| Comparative | Paint AS4 | 5 | 14.8 | 3.0 × 10¹⁰ | 40 | Blur and blotch | Positive |
| Example AS4 | | | | | | observed | |

In the Table, the thickness means an arithmetic average film thickness (m) of the surface layer, and the content percentage of particles means the content percentage (vol %) of tin oxide particles in relation to the surface layer.

As shown in Table 4, it was suggested that when the surface layer contained at least one copolymer selected from the group consisting of a polyoxyethylene-polycaprolactone copolymer and a polyoxyethylene-polyvalerolactone copolymer, the tin oxide particles in the surface layer moderately agglomerated, resulting in small residual potential due to decreased surface resistivity.

As the Comparative Example AS4, even if the surface layer does not contain a copolymer, surface resistivity can be lowered by increasing the amount of conductive filler. However, it can be inferred that blurred or blotchy images will be more likely to occur because the surface layer has become harder, and the surface layer has hardly been scraped off even after a large number of prints.

### Production Example of Paint B1

The following materials were mixed using a magnetic stirrer to prepare a paint B1.

| | |
|---|---|
| A mixture of pentaerythritol triacrylate and | 70 parts by mass |
| pentaerythritol tetraacrylate (trade name: | |
| M306, manufactured by Toagosei Co., Ltd.) | |
| Methyl ethyl ketone (manufactured by | 50 parts by mass |
| Kishida Chemical Co., Ltd.) | |
| 2-Propanol (manufactured by Kishida | 50 parts by mass |
| Chemical Co., Ltd.) | |
| 1-Hydroxycyclohexyl phenyl ketone | 5 parts by mass |
| (manufactured by Tokyo Chemical | |
| Industry Co., Ltd.) | |
| Photopolymerization initiator (Esacure ONE, | 3 parts by mass |
| manufactured by IGM Resins B.V.) | |
| Dispersing liquid γ1 | 40 parts by mass |

### Preparation of Paint B2

Paints B2 to B4 and paints BS1 to BS4 were prepared in the same manner as the paint B1, except that the type of the monomer and dispersing liquid and the amount of the dispersing liquid were changed to those listed in Table 5. Here, the following material was used.
Urethane acrylate: trade name U-6LPA, manufactured by Shin-Nakamura Chemical Co., Ltd.

TABLE 5

| | | | Net weight of |
|---|---|---|---|
| | | Dispersing | dispersing liquid |
| | Monomer | liquid | (parts by mass) |
| Paint B1 | Mixture of pentaerythritol | γ1 | 40 |
| | triacrylate and | | |
| | pentaerythritol tetraacrylate | | |
| Paint B2 | Mixture of pentaerythritol | γ2 | 40 |
| | triacrylate and | | |
| | pentaerythritol tetraacrylate | | |
| Paint B3 | Mixture of pentaerythritol | γ3 | 20 |
| | triacrylate and | | |
| | pentaerythritol tetraacrylate | | |
| Paint B4 | Urethane acrylate U-6LPA | γ4 | 105 |
| Paint BS1 | Mixture of pentaerythritol | γS1 | 40 |
| | triacrylate and | | |
| | pentaerythritol tetraacrylate | | |
| Paint BS2 | Mixture of pentaerythritol | γS2 | 40 |
| | triacrylate and | | |
| | pentaerythritol letraacrylate | | |
| Paint BS3 | Mixture of pentaerythritol | γS3 | 40 |
| | triacrylate and | | |
| | pentaerythritol tetraacrylate | | |
| Paint BS4 | Mixture of pentaerythritol | γS1 | 170 |
| | triacrylate and | | |
| | pentaerythritol tetraacrylate | | |

### Example B1

The outer peripheral surface of a polyimide intermediate transfer belt (monolayer) having an endless shape with carbon black dispersed, installed in the full-color electrophotographic image forming apparatus (trade name: imageRUNNER ADVANCE C5051; manufactured by Canon Inc.) was corona-treated. After that, the paint B1 was coated on the outer peripheral surface so that the dried film thickness should be 5 μm, and then dried at 70° C. for 3 minutes. After that, the intermediate transfer belt was irradiated with a UV ray with a high-pressure mercury lamp in a condition of a peak illuminance at 365 nm of 200 mW/cm² and a cumulative light amount of 2 J/cm² to form a surface layer, thereby preparing an intermediate transfer belt 1. In this Example, a layer made of a polyimide seamless belt corresponds to the base layer.

### Examples B2 to B4 and Comparative Examples BS1 to BS4

Intermediate transfer belts B2 to B4 and intermediate transfer belts BS1 to BS4 were prepared in the same manner as Example B1, except that the type of the paint was changed as indicated in Table 6, and the thickness was set to that indicated in Table 6.

### Measurement of Volume Resistivity ρv1

The volume resistivity ρv1 was measured in accordance with JIS K 6911 with a UR probe using Hiresta-UX (manufactured by Mitsubishi Chemical Analytech Co., Ltd.) while applying the voltage of 10 V. Table 6 shows the results.

### Measurement of Volume Resistance Rate ρv2

The surface layer of the intermediate transfer belt was removed by scraping using an aluminum oxide lapping film sheet manufactured by 3M Company, and the intermediate transfer belt was cleaned using Toraysee MK, manufactured by Toray Industries, Inc. The volume resistivity ρv2 was measured in accordance with JIS K 6911 with a UR probe using Hiresta-UX (manufactured by Mitsubishi Chemical Analytech Co., Ltd.) while applying the voltage of 10 V.

A value of log₁₀(ρv1/ρv2) was calculated using the obtained values of ρv1 and ρv2.

### Evaluation of Image Defects

Using a copier (trade name: iR ADVANCE C5560F, manufactured by Canon Inc.), the cycle of printing 995 images for continuous printing as shown below and thereafter printing 5 images for checking image defects as shown below was repeated 100 times to complete 100,000 prints. The environment was set at a temperature of 23° C. and a relative humidity of 5%.

### Images for Continuous Printing

Paper used: GF-C081, A4 size (basis weight: 81.4 g/m², thickness: 97 μm, whitechromaticity: about 100%, manufactured by Canon Inc.)
Printing image; all of CMYK toners onto the intermediate transfer belt were used, image ratio: 20%

### Image for Checking Image Defects

Paper used: GF-C081, A3 size (basis weight: 81.4 g/m², thickness: 97 μm, whitechromaticity: about 100%, manufactured by Canon Inc.)
Printing image: a half-tone image only with a K toner (concentration: 50%), image ratio: 100%

### Evaluation of Cleaning Properties

Using a copier (trade name: iR ADVANCE C5560F, manufactured by Canon Inc.), the cycle of printing 995 images for continuous printing as shown below and thereafter printing 5 images for checking image defects as shown below was repeated 100 times to complete 100,000 prints. The environment was set at a temperature of 30° C. and a relative humidity of 80%.

### Images for Continuous Printing

Paper used: GF-C081, A4 size (basis weight: 81.4 g/m², thickness: 97 μm, whitechromaticity: about 100%, manufactured by Canon Inc.)
Printing image; all of CMYK toners onto the intermediate transfer belt were used, image ratio: 5%

### Image for Checking Image Defects

Paper used: GF-C081, A3 size (basis weight: 81.4 g/m², thickness: 97 μm, whitechromaticity: about 100%, manufactured by Canon Inc.)
Printing image: image ratio of 0%

A case where image defects originating from faulty cleaning of a transfer belt in the image for checking image defects occurred was evaluated as “occurred”, and the case where image defects did not occur was evaluated as “not occurred”. Table 6 shows all the results.

TABLE 6

| | | | Volume | | Content | | | |
|---|---|---|---|---|---|---|---|---|
| | | | resistivity ρv1 | | percentage | | | |
| | | Thickness | (Applied voltage | | of particles | Image | Defects of | L |
| | Paint | (μm) | 100 V, Q · cm) | log₁₀(ρv1/ρv2) | (vol %) | irregularities | CLN | function |
| Example B1 | Paint B1 | 5 | 2.0E+09 | 1.5 | 3.9 | Not occurred | Not occurred | Positive |
| Example B2 | Paint B2 | 5 | 1.0E+10 | 2.0 | 3.9 | Not occurred | Not occurred | Positive |
| Example B3 | Paint B3 | 5 | 2.0E+10 | 1.8 | 2.0 | Not occurred | Not occurred | Positive |
| Example B4 | Paint B4 | 5 | 5.0E+09 | 2.2 | 10.0 | Not occurred | Not occurred | Positive |
| Example B5 | Paint B1 | 2 | 1.3E+08 | 0.5 | 3.9 | Not occurred | Not occurred | Positive |
| Example B6 | Paint B1 | 10 | 7.0E+11 | 3.5 | 3.9 | Not occurred | Not occurred | Positive |
| Comparative | Paint BS1 | 5 | 1.0E+13 | 4.0 | 3.9 | Occurred | Not occurred | Negative |
| Example BS1 | | | | | | | | |
| Comparative | Paint BS2 | 5 | 7.0E+12 | 3.8 | 3.9 | Occurred | Not occurred | Negative |
| Example BS2 | | | | | | | | |
| Comparative | Paint BS3 | 5 | 2.0E+13 | 4.5 | 3.9 | Occurred | Not occurred | Negative |
| Example BS3 | | | | | | | | |
| Comparative | Paint BS4 | 5 | 2.0E+10 | 2.0 | 14.8 | Not occurred | Occurred | Positive |
| Example BS4 | | | | | | | | |

In the Table, the thickness means an arithmetic average film thickness (m) of the surface layer, and the content percentage of particles means the content percentage (vol %) of tin oxide particles in relation to the surface layer.

As shown in Table 6, it was found that when the surface layer contained at least one copolymer selected from the group consisting of a polyoxyethylene-polycaprolactone copolymer and a polyoxyethylene-polyvalerolactone copolymer, the tin oxide particles in the surface layer moderately agglomerated, resulting in a decrease in volume resistivity. As a result, no image irregularities occurred, and a transfer belt with good cleaning properties was obtained.

Meanwhile, in the Comparative Examples BS1 to BS3, tin oxide particles were not moderately agglomerated, resulting in image irregularities due to high volume resistivity. In Comparative Example BS4, the volume resistivity could be lowered, and the occurrence of image irregularities was prevented by adding a large amount of conductive filler. However, because the surface layer became hard, the cleaning member was scraped off during a large number of prints, resulting in image defects derived from faulty cleaning.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-121972, filed Jul. 26, 2023 which is hereby incorporated by reference herein in its entirety.

What is claimed is:

1. An electrophotographic member at least comprising:
a base layer; and
a surface layer on the base layer, wherein
the surface layer comprises a binder resin, a tin oxide-containing particle, and at least one copolymer selected from the group consisting of a polyoxyethylene-polycaprolactone copolymer and a polyoxyethylene-polyvalerolactone copolymer;
the binder resin comprises a (meth)acrylic resin;
the copolymer has at least one functional group selected from the group consisting of a carboxy group and a phosphate group; and
a content percentage of the particle in relation to the surface layer is 2.0% to 10.0% by volume.

2. The electrophotographic member according to claim 1, wherein
the particle comprises at least one selected from the group consisting of antimony-doped tin oxide and phosphorous-doped tin oxide.

3. The electrophotographic member according to claim 1, wherein
the electrophotographic member is an electrophotographic belt.

4. The electrophotographic member according to claim 3, wherein
when ρv1 is a volume resistivity of the electrophotographic member, and ρv2 is a volume resistivity measured after removing the surface layer from the electrophotographic member, ρv1 and ρv2 satisfy formulas (1) and (2) below:
$$\begin{matrix}0.5 \leq {log}_{10} ( ρ v 1 / ρ v 2 ) \leq 3.5 & ( 1 ) \\ 1. \times {10}^{8} Ω \cdot cm \leq ρ v 1 \leq 1. \times {10}^{12} Ω \cdot cm & ( 2 )\end{matrix}$$

5. The electrophotographic member according to claim 1, wherein
the electrophotographic member is an electrophotographic photoreceptor.

6. The electrophotographic member according to claim 5, wherein
the surface resistivity of the surface layer when 100 V is applied is 3.0×10⁹ to 1.0×10¹² Ω/sq.

7. The electrophotographic member according to claim 1, wherein
the surface layer has an arithmetic average film thickness of 2 to 10 km.

8. The electrophotographic member according to claim 1, wherein
the copolymer has a number average molecular weight of 600 to 2,000 and a content percentage of polyoxyethylene units in the copolymer is 29% to 44% by mass.

9. The electrophotographic member according to claim 1, wherein
in an L function indicating a relationship of distribution of the tin oxide-containing particle observed from a surface of the surface layer, a value of the L function at a distance within a range of 300 nm to 1 μm from a center-of-gravity coordinate of the particle is always positive.

10. A process cartridge configured to be detachable with respect to a body of an electrophotographic image forming apparatus, the process cartridge being provided with the electrophotographic member according to claim 1.

11. An electrophotographic image forming apparatus, the electrophotographic image forming apparatus being provided with an electrophotographic member, wherein
the electrophotographic member comprises at least
a base layer; and
a surface layer on the base layer,
the surface layer comprises a binder resin, a tin oxide-containing particle, and at least one copolymer selected from the group consisting of a polyoxyethylene-polycaprolactone copolymer and a polyoxyethylene-polyvalerolactone copolymer;
the binder resin comprises a (meth)acrylic resin;
the copolymer has at least one functional group selected from the group consisting of a carboxy group and a phosphate group; and
a content percentage of the particle in relation to the surface layer is 2.0% to 10.0% by volume.
